(19) United States
(12) Patent Application Publication
(10) Pub. No.: US 2022/0033220 A1
(43) Pub. Date: Feb. 3, 2022

(54) ELEVATOR CROWD REDUCTION

(71) Applicant: OTIS ELEVATOR COMPANY, Farmington, CT (US)

(72) Inventors: Sandeep Sudi, Farmington, CT (US); Vijayakumar Marada, Hitech City (IN); Phani Krishna Pogula, Hyderabad (IN)

(21) Appl. No.: 17/381,409

(22) Filed: Jul. 21, 2021

(30) Foreign Application Priority Data
Jul. 31, 2020 (IN) 202011032922

(51) Int. Cl. B66B 5/14; B66B 1/34; B66B 1/46; B66B 13/14

(52) U.S. Cl. CPC B66B 5/145; B66B 1/3407; B66B 1/3476; B66B 2201/23; B66B 13/143; B66B 2201/222; B66B 1/468

(57) ABSTRACT

A system includes an elevator system including an elevator car. The system also includes a control system configured to receive a crowd reduction indicator, determine an elevator car load reduction for the elevator car based on the crowd reduction indicator, adjust an elevator car load limit based on the elevator car load reduction, and trigger a mitigation action in the elevator system based on detecting a condition that exceeds the elevator car load limit.

### CROSS-REFERENCE TO RELATED APPLICATIONS

This application claims the benefit of the IN Application No. 202011032922 filed Jul. 31, 2020, which is incorporated herein by reference in its entirety.

### BACKGROUND

Exemplary embodiments pertain to the art of elevator systems and, more particularly, to crowd reduction in elevator systems.

Elevators can vary in usage as occupancy levels at lobby areas change over time. Elevator crowding can be inconvenient and, in some cases, may raise health concerns for elevator passengers. Elevator cars have a maximum loading capacity to handle large loads; however, in some instances it may be preferable to operate the elevator car at a loading level less than the maximum loading capacity. For example, where social distancing between elevator car passengers is desirable, some passengers may decide to overlook the guidelines and crowd into an elevator car in order to reach a desired destination faster, regardless of the guidelines.

### BRIEF DESCRIPTION

Disclosed is a system that includes an elevator system including an elevator car. The system also includes a control system configured to receive a crowd reduction indicator, determine an elevator car load reduction for the elevator car based on the crowd reduction indicator, adjust an elevator car load limit based on the elevator car load reduction, and trigger a mitigation action in the elevator system based on detecting a condition that exceeds the elevator car load limit.

In addition to one or more of the features described herein, or as an alternative, further embodiments may include where the crowd reduction indicator is received based on a local trigger source.

In addition to one or more of the features described herein, or as an alternative, further embodiments may include where the crowd reduction indicator is received through a network based on a remote trigger source.

In addition to one or more of the features described herein, or as an alternative, further embodiments may include one or more sensors configured to monitor a load status of the elevator car, where detecting the condition that exceeds the elevator car load limit is based on the load status.

In addition to one or more of the features described herein, or as an alternative, further embodiments may include where a call request for the elevator car is latched based on determining that the elevator car has reached the elevator car load limit.

In addition to one or more of the features described herein, or as an alternative, further embodiments may include where the mitigation action includes triggering an alert system external to the elevator car.

In addition to one or more of the features described herein, or as an alternative, further embodiments may include where the mitigation action includes triggering an alert system within the elevator car.

In addition to one or more of the features described herein, or as an alternative, further embodiments may include where the control system is configured to monitor for a load status of the elevator car being reduced from above the elevator car load limit to below the elevator car load limit and initiates closure of an elevator door of the elevator car based on determining that the load status of the elevator car has been reduced below the elevator car load limit.

In addition to one or more of the features described herein, or as an alternative, further embodiments may include where the mitigation action includes sending an elevator dispatch call to request another elevator car to a same landing location where the elevator car is located upon exceeding the elevator car load limit.

In addition to one or more of the features described herein, or as an alternative, further embodiments may include where the control system is configured to restore the elevator car load limit from a reduced value to a default value based on a default load limit indicator.

Also disclosed is a method that includes receiving, at a control system of an elevator system comprising an elevator car, a crowd reduction indicator. An elevator car load reduction is determined for the elevator car based on the crowd reduction indicator. An elevator car load limit is adjusted based on the elevator car load reduction. A mitigation action in the elevator system is triggered based on detecting a condition that exceeds the elevator car load limit.

In addition to one or more of the features described herein, or as an alternative, further embodiments may include monitoring one or more sensors configured to indicate a load status of the elevator car, where detecting the condition that exceeds the elevator car load limit is based on the load status.

In addition to one or more of the features described herein, or as an alternative, further embodiments may include latching a call request for the elevator car based on determining that the elevator car has reached the elevator car load limit.

In addition to one or more of the features described herein, or as an alternative, further embodiments may include monitoring for a load status of the elevator car being reduced from above the elevator car load limit to below the elevator car load limit, and initiating closure of an elevator door of the elevator car based on determining that the load status of the elevator car has been reduced below the elevator car load limit.

In addition to one or more of the features described herein, or as an alternative, further embodiments may include restoring the elevator car load limit from a reduced value to a default value based on a default load limit indicator.

### BRIEF DESCRIPTION OF THE DRAWINGS

The following descriptions should not be considered limiting in any way. With reference to the accompanying drawings, like elements are numbered alike:

FIG. 1 is a schematic illustration of an elevator system according to an embodiment of the present disclosure;

FIG. 2 is a system for managing elevator dispatching with selective crowd reduction, according to an embodiment of the present disclosure;

FIG. 3 is a system for monitoring crowding within an elevator car, according to an embodiment of the present disclosure;

FIG. 4 depicts an interior of an elevator car with passengers spaced for a social distancing constraint, according to an embodiment of the present disclosure; and

FIG. 5 is a flow diagram illustrating a process, according to an embodiment of the present disclosure.

### DETAILED DESCRIPTION

A detailed description of one or more embodiments of the disclosed apparatus and method are presented herein by way of exemplification and not limitation with reference to the Figures.

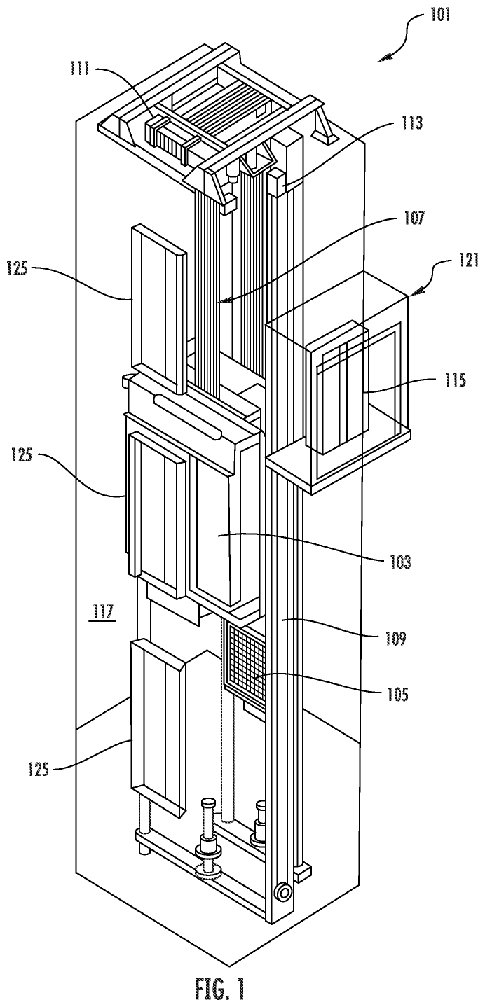

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator hoistway 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator hoistway 117, such as on a support or guide rail, and may be configured to provide position signals related to a position of the elevator car 103 within the elevator hoistway 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator hoistway 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator hoistway 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator hoistway 117.

Although shown and described with a roping system including tension member 107, elevator systems that employ other methods and mechanisms of moving an elevator car within an elevator hoistway may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. Embodiments may also be employed in ropeless elevator systems using self-propelled elevator cars (e.g., elevator cars equipped with friction wheels or traction wheels). FIG. 1 is merely a non-limiting example presented for illustrative and explanatory purposes.

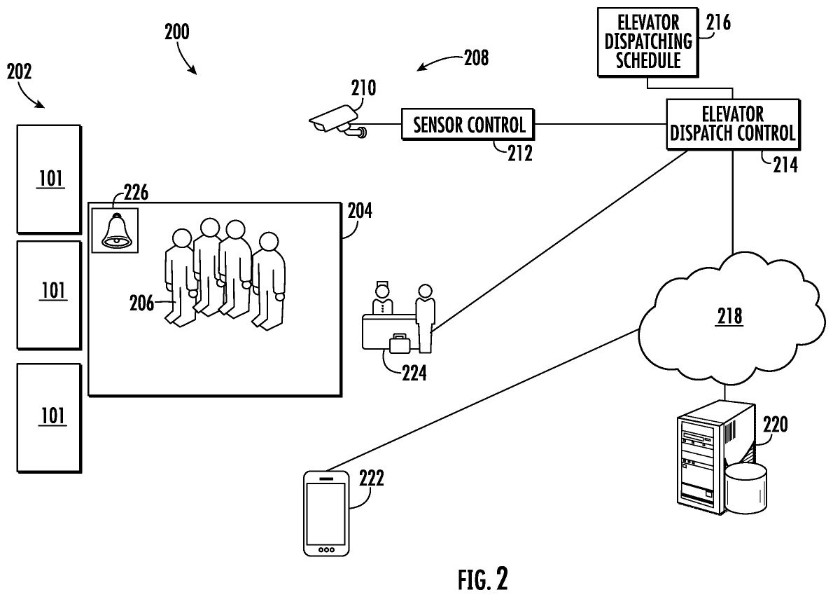

Turning now to FIG. 2, an exemplary system 200 for managing elevator dispatching with selective crowd reduction in accordance with one or more embodiments is shown. The system 200 may include one or more elevator systems 101 managed as an elevator group 202 accessible at multiple landings. Within a structure, such as a building, in which the elevator group 202 is installed, there can be one or more lobby areas 204 at one or more floors where crowds 206 of potential elevator passengers may gather. For instance, lobby areas 204 may be on a ground floor or another level, such as a sky lobby or a floor with conference rooms, ball rooms, or other such areas where larger crowds may congregate. The system 200 can include a sensing system 208 configured to capture crowd data associated with a lobby area 204 of an elevator system 101. The sensing system 208 may include one or more sensors 210 and sensor control 212. In systems where multiple sensors are employed, the sensors 210 may be a common type of sensor or varied. Any type of sensor 210 suitable for object detection may be employed. For example, sensors that rely on infrared, radar, video, LIDAR, time of flight, 2D or 3D depth sensing, floor pressure sensors, and suitable alternatives, may be utilized. The sensors 210 may be positioned in various locations. For example, the sensors 210 may be located on the floor of a lobby area 204, or at elevated positions fixed to a structure in the lobby area 204. Sensor control 212 can be an edge computing node with image tracking, classification, and counting logic using one or more techniques known in the art to observe and track a number of people in the crowd 206 which may be quantified as crowd data. In some embodiments, the crowd data tracking 210 can include tracking an occupancy level in one or more lobby areas 204 and within elevator cars 103 of the elevator systems 101.

The system 200 can also include an elevator dispatch control 214 that is configured to receive the crowd data from the sensor control 212 or raw sensor data. The elevator dispatch control 214 can adjust a dispatching schedule 216 of one or more elevator cars 103 of the elevator group 202 of elevator systems 101 based on the crowd data. For example, the dispatching schedule 216 can be adjusted to position an increased number of elevator cars 103 in close proximity to floors of the lobby area 204 with increased crowds. Elevator dispatch control 214 can interface with controllers 115 of FIG. 1 as an example of elevator controllers. The elevator dispatch control 214 can also interface with a network 218, which can be part of a cloud computing environment configured to communicate with a plurality of devices. As one example, a server 220 can be connected to network 218 and implemented using known computing equipment (e.g., processor, memory, I/O devices, network communications, etc.). The server 220 may be implemented using the same equipment the elevator dispatch control 214 or may be a separate component. The network 218 may be a local network (e.g., 802.xx) or a wide range network (e.g., cellular) and may be implemented using known wired and/or wireless network protocols. The sensor control 212 and elevator dispatch control 214 can also be implemented using known processing circuitry, memory systems, communication interfaces and the like to execute instructions embodied in a non-transitory format.

The network 218 can also communicate with at least one user devices, such as mobile devices 222, that can be associated with the crowd 206 or a manager/supervisor system. Examples of mobile devices 222 can include a smartphone, a laptop, a tablet, smartwatch, etc. One or more of the mobile devices 222 may be associated with a particular user. The user may use his/her mobile device(s) 222 to request an elevator car 103 of FIG. 1. A request can be a call that allows an empty or partially filled elevator car 103 to be dispatched to a floor. The request can be manually initiated (e.g., on-demand) or initiated in response to sensor data. For automated requests based on sensor data, there can be a plurality of rules defined and/or predetermined schedules established. Rule-based systems can incorporate machine learning and artificial intelligence to dynamically define rules and further refine rules over a period of time. Artificial intelligence algorithms may be trained with a set of training data prior to deployment and further refined in the field to align with usage patterns of a particular building design and flow of traffic (e.g., passengers and/or cargo) for the elevator systems 101. Artificial intelligence algorithms can learn to predict timing, size, and locations of the crowd 206 and automatically set or modify dispatching profiles predictively before the crowd 206 arrives or fully forms, for instance, at lobby area 204.

The request for an elevator car 103 may be conveyed or transmitted from the mobile device 222 over one or more networks 218. For example, the request may be transmitted via the Internet and/or a cellular network. The request may then be routed through server 220 to the elevator dispatch control 214, or the mobile device 222 can directly communicate with any component of the elevator system 101.

The elevator dispatch control 214 may select a resource (e.g., an elevator system 101 or elevator car 103) that is suited to fulfill a service request, potentially based on one or more considerations, such as power consumption/efficiency, quality of service (e.g., reduction in waiting time until a user or passenger arrives at a destination floor or landing), etc.

In embodiments, a system, such as the elevator dispatch control 214 or server 220, can use crowd data to alert passengers, use in-car space data to dispatch empty elevator cars 103 to users and communicate assignments to a management system. Elevator cars 103 with empty space can be identified and allocated through the dispatching schedule 216 to help users move themselves, luggage, companions, and the like to a desired location. In some embodiments, crowd data is used to determine when a lobby area 204 is sufficiently clear to notify a user to proceed to the lobby area 204. People counting techniques can be used to measure wait times to improve the user experience.

Further, crowd sensing features can be a subscription-based service that an operator of the elevator systems 101, e.g., a building owner pays for to ensure an improved user experience. For example, crowd sensing can be selectively enabled for certain locations within a building, such as the lobby area 204. Further, timing of enablement of crowd sensing can change over time. For instance, if a large conference is scheduled, the elevator dispatching schedule 216 can be predictively adjusted based on schedule data. Further, on-demand crowd sensing can be selectively enabled for particular floors or any floors. Trending data can also be captured to better understand a history of user movement and crowds 206.

Embodiments can support crowd reduction within the elevator cars 103 of the elevator systems 101 based on a crowd reduction indicator. The crowd reduction indicator can be used to lower a maximum load or number of passengers per elevator car 103. For example, where greater social distancing between elevator car passengers is desired, assertion of the crowd reduction indicator can trigger lowering of an elevator car load limit. For instance, a default value of the elevator car load limit may be ten passengers, while the reduced value of the elevator car load limit may be three or four passengers. The crowd reduction indicator can be asserted based on scheduling, for instance, based on a time of day, week, and/or month. Further, the crowd reduction indicator can be set based on sensed crowding or predicted crowding. The crowd reduction indicator can be set using automation, scheduling, and/or a manual request. For instance, a manager or attendant can directly set or establish a schedule of desired elevator crowd reduction through a computer system 224 configured to relay the request to the elevator dispatch control 214, to server 220, and/or to controller 115 to set the crowd reduction indicator. Where the mobile device 222 has administrative/service permissions, the mobile device 222 can be used to schedule or immediately update the state of the crowd reduction indicator.

Upon setting of the crowd reduction indicator, an alert system 226 can be triggered to provide an audio/visual indication that the elevator systems 101 are operating in a crowd reduction mode. The alert system 226 can include one or more of a light, buzzer, bell, sign, or the like. Further, the alert system 226 can inform passengers of the loading constraints (e.g., maximum of four passengers per elevator car 103) to discourage passengers from overcrowding. The alert system 226 may output announcements indicating spacing guidelines and related information for people waiting for one of the elevator cars 103 in a lobby or hallway. The alert system 226 may also trigger notification messages to mobile devices 222 with the change in the operating mode of the elevator systems 101.

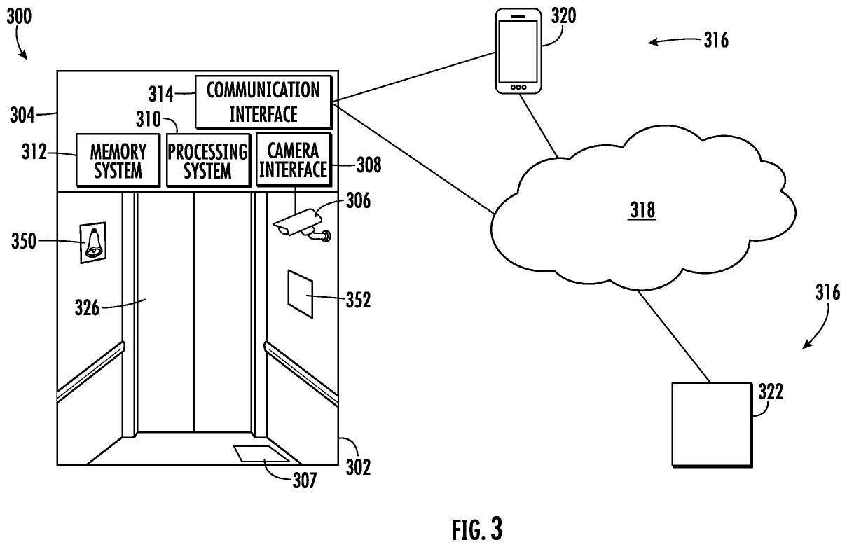

FIG. 3 depicts an example of a system 300 according to an embodiment. The system 300 includes a passenger enclosure 302, which may be the elevator car 103 of FIG. 1. The system 300 also includes a monitoring system 304 operably coupled to one or more sensors 306, such as one or more video cameras configured to capture image data at a conveyance system, such as elevator system 101 of FIG. 1. In the example of FIG. 3, there is a single instance of the video camera within the passenger enclosure 302. In alternate embodiments, there may be multiple instances video cameras, for instance, to capture multiple angles within the passenger enclosure 302, to perform depth measurements (e.g., in a stereoscopic configuration), and/or to observe areas that may otherwise be obstructed using a single camera in the passenger enclosure 302. Other types of sensors can include pressure plates 307 or other such passenger detection systems.

The monitoring system 304 can also include a processing system 310, a memory system 312, and a communication interface 314, as well as other subsystems (not depicted). In some embodiments, the processing system 310 is configured to capture passenger data and perform processing to analyze the content of the passenger data. In other embodiments, the processing system 310 provides captured image data through the communication interface 314 for off-board processing, such as processing performed at the controller 115 of FIG. 1, or another location, such as cloud-based processing through a network 318 and/or other computing resources.

The processing system 310 may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory system 312 may be a storage device such as, for example, a random access memory (RAM), read only memory (ROM), or other electronic, optical, magnetic or any other computer readable storage medium. The memory system 312 can include computer-executable instructions that, when executed by the processing system 310, cause the processing system 310 to perform operations as further described herein.

The communication interface 314 can include wired, wireless, and/or optical communication links to establish communication with one or more support systems 316 either directly or through the network 318. Examples of the support systems 316 can include a mobile device 320 or any type of computer system 322, such as a personal computer, a workstation, a laptop computer, a tablet computer, wearable computer, or a custom-built computer system, and/or the controller 115 of FIG. 1. The computer system 322 may be a central control computer that monitors the functionality of multiple instances of the elevator system 101, such as multiple elevators in the same building or structure. The computer system 322 may also or alternatively be part of a system that monitors conditions within the passenger enclosure 302. The computer system 322 may also be part of an elevator service system to monitor and control conditions pertaining to the elevator system 101. The network 318 can also support cloud-based operations and processing to directly support or partially offload processing burdens of the processing system 310.

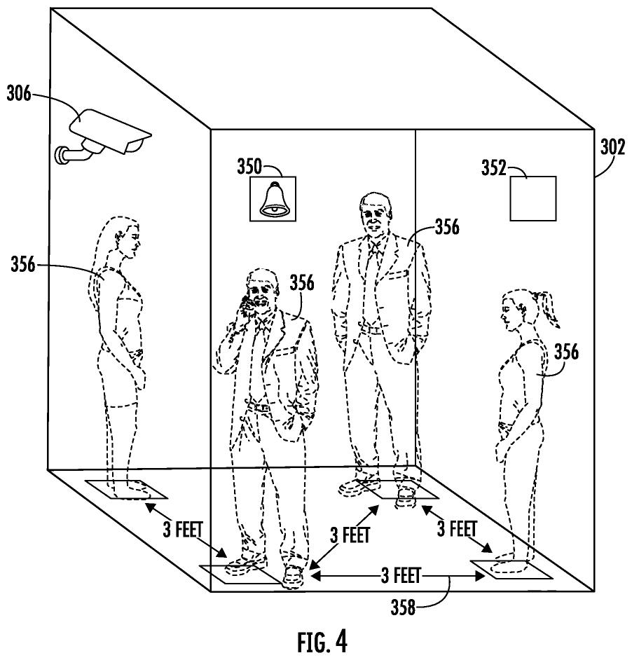

With respect to FIGS. 3 and 4, an alert system 350 within the passenger enclosure 302 can be used to notify passengers 356 when an elevator car load limit has been exceeded. Further, a display unit 352 can indicate an operating mode and constraints of passenger load limits. For example, when the elevator car load limit has been exceeded, the alert system 350 may be triggered to notify passengers that the passenger count must be reduced before elevator door 326 will be allowed to close. The display unit 352 may provide more detailed information and suggestions for distancing between passengers within the passenger enclosure 302. The alert system, 350 may provide a standard safety announcement to notify the passengers 356 of minimum social distancing guidance presently being enforced, which can include a maximum number of passengers 356 to maintain a minimum separation distance 358. The maximum number of passengers 356 and minimum separation distance 358 can be configurable parameters set according to local guidelines, the internal volume of the passenger enclosure 302, and/or other factors. As one example, the maximum number of passengers 356 can be set to three or four passengers 356, and the minimum separation distance 358 may be one meter or about three feet. In one embodiment, the maximum number of passengers 356 can be set to any number, such as less than three or more than four. In some embodiments, the display unit 352 or other indicators may indicate preferred locations for the passengers 356 to position themselves within the passenger enclosure 302 to ensure that the minimum separation distance 358 is maintained.

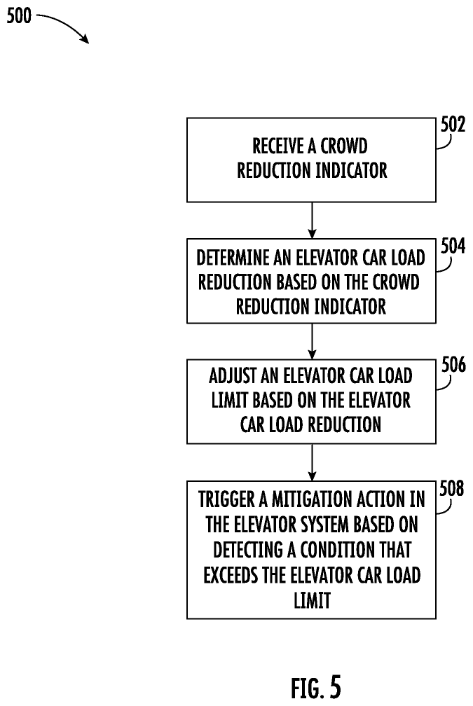

Referring now to FIG. 5 with continued reference to FIGS. 1-5, FIG. 5 depicts a flow chart of a method 500 in accordance with an embodiment of the disclosure. The method 500 can be performed, for example, by the systems 200 and 300 of FIGS. 2-4.

At block 502, a control system 115 of an elevator system 101 including an elevator car 103, can receive a crowd reduction indicator. The crowd reduction indicator can be received based on a local trigger source, such as sensor-based observation through a sensor 210, a command sent through mobile device 222, 320, a locally programmed schedule, or a computer system 224. Alternatively, the crowd reduction indicator can be received through a network 218, 318 based on a remote trigger source, such as a server 220, a remotely connected mobile device 222, 320, or other computer system 322.

At block 504, an elevator car load reduction can be determined for the elevator car 103 based on the crowd reduction indicator. For example, detecting assertion of the crowd reduction indicator can result in determining an associated reduction in the maximum number of passengers per elevator car 103.

At block 506, the elevator car load limit can be adjusted based on the elevator car load reduction. The reduction can be based on weight, passenger count, or other unit of measurement.

At block 508, a mitigation action can be triggered in the elevator system 101 based on detecting a condition that exceeds the elevator car load limit. One or more sensors 306, 307 can be monitored, where the sensors 306, 307 are configured to indicate a load status of the elevator car 103. Detecting a condition that exceeds the elevator car load limit can be based on the load status. As another example, the load status of the elevator car 103 can be determined based on feedback of a machine 111 configured to control movement of the elevator car 103, e.g., changes in torque or power needed to move the elevator car 103. The mitigation action can include triggering an alert system 226 external to the elevator car 103. Further, the mitigation action can include triggering an alert system 350 within the elevator car 103. The mitigation action can include sending an elevator dispatch call to request another elevator car to a same landing location where the elevator car 103 is located upon exceeding the elevator car load limit, for instance, through elevator dispatch control 214.

In some embodiments, monitoring for a load status of the elevator car 103 being reduced from above the elevator car load limit to below the elevator car load limit can be performed. Closure of an elevator door 326 of the elevator car 103 can be initiated based on determining that the load status of the elevator car has been reduced below the elevator car load limit. The elevator car load limit can be restored from a reduced value to a default value based on a default load limit indicator. For instance, when reduced loading is no longer needed or a heavier item needs to be transported in the elevator car 103, the default load limit indicator can indicate the resumption of normal (e.g., non-reduced crowd size limited) operation. A call request for the elevator car 103 can be latched based on determining that the elevator car 103 has reached the elevator car load limit. For example, call requests from a hall call button or through a mobile device can be ignored to prevent overloading of an elevator car 103 that has reached capacity. Another elevator car 103 that has not reached capacity can be dispatched to service a call.

While the above description has described the flow process of FIG. 5 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A system comprising:
an elevator system comprising an elevator car; and
a control system configured to receive a crowd reduction indicator, determine an elevator car load reduction for the elevator car based on the crowd reduction indicator, adjust an elevator car load limit based on the elevator car load reduction, and trigger a mitigation action in the elevator system based on detecting a condition that exceeds the elevator car load limit.

2. The system of claim 1, wherein the crowd reduction indicator is received based on a local trigger source.

3. The system of claim 1, wherein the crowd reduction indicator is received through a network based on a remote trigger source.

4. The system of claim 1, further comprising one or more sensors configured to monitor a load status of the elevator car, wherein detecting the condition that exceeds the elevator car load limit is based on the load status.

5. The system of claim 1, wherein a call request for the elevator car is latched based on determining that the elevator car has reached the elevator car load limit.

6. The system of claim 1, wherein the mitigation action comprises triggering an alert system external to the elevator car.

7. The system of claim 1, wherein the mitigation action comprises triggering an alert system within the elevator car.

8. The system of claim 1, wherein the control system is configured to monitor for a load status of the elevator car being reduced from above the elevator car load limit to below the elevator car load limit and initiates closure of an elevator door of the elevator car based on determining that the load status of the elevator car has been reduced below the elevator car load limit.

9. The system of claim 1, wherein the mitigation action comprises sending an elevator dispatch call to request another elevator car to a same landing location where the elevator car is located upon exceeding the elevator car load limit.

10. The system of claim 1, wherein the control system is configured to restore the elevator car load limit from a reduced value to a default value based on a default load limit indicator.

11. A method comprising
receiving, at a control system of an elevator system comprising an elevator car, a crowd reduction indicator;
determining an elevator car load reduction for the elevator car based on the crowd reduction indicator;
adjusting an elevator car load limit based on the elevator car load reduction; and
triggering a mitigation action in the elevator system based on detecting a condition that exceeds the elevator car load limit.

12. The method of claim 11, wherein the crowd reduction indicator is received based on a local trigger source.

13. The method of claim 11, wherein the crowd reduction indicator is received through a network based on a remote trigger source.

14. The method of claim 11, further comprising:
monitoring one or more sensors configured to indicate a load status of the elevator car, wherein detecting the condition that exceeds the elevator car load limit is based on the load status.

15. The method of claim 11, further comprising:
latching a call request for the elevator car based on determining that the elevator car has reached the elevator car load limit.

16. The method of claim 11, wherein the mitigation action comprises triggering an alert system external to the elevator car.

17. The method of claim 11, wherein the mitigation action comprises triggering an alert system within the elevator car.

18. The method of claim 11, further comprising:
monitoring for a load status of the elevator car being reduced from above the elevator car load limit to below the elevator car load limit; and
initiating closure of an elevator door of the elevator car based on determining that the load status of the elevator car has been reduced below the elevator car load limit.

19. The method of claim 11, wherein the mitigation action comprises sending an elevator dispatch call to request another elevator car to a same landing location where the elevator car is located upon exceeding the elevator car load limit.

20. The method of claim 11, further comprising:
restoring the elevator car load limit from a reduced value to a default value based on a default load limit indicator.
